(19) United States
(12) Patent Application Publication
(10) Pub. No.: US 2025/0248873 A1
(43) Pub. Date: Aug. 7, 2025

(54) Bedside Step

(71) Applicant: Guangdong Shengtuo Trading Development Co., Ltd., Guangzhou (CN)

(72) Inventor: LinJiu OuYang, Guangzhou (CN)

(21) Appl. No.: 18/668,133

(22) Filed: May 18, 2024

(30) Foreign Application Priority Data
Feb. 2, 2024 (CN) 202420253354.6

(51) Int. Cl. A61G 7/053

(52) U.S. Cl. CPC A61G 7/053; A61G 2203/30

(57) ABSTRACT

The disclosure relates to the technical field of assistive equipment, in particular to a bedside step comprising an underframe, a base plate and a sideframe, wherein the sideframe is disposed at one end of the underframe, the base plate is disposed on the underframe, a plurality of sensor lamps are disposed in the underframe, the base plate is provided with a plurality of holes whose positions correspond to positions of the plurality of sensor lamps, a sensor which is electrically connected with the plurality of sensor lamps is disposed on the sideframe, and a plurality of support rods are further disposed at a bottom of the underframe. According to the bedside step provided by the disclosure, due to the providing of the sensor, so that when the user approaches the bedside step, the sensor lamps which are electrically connected with the sensor light up, and the bedside step can be clearly seen even in the dark, which is further convenient for the user.

### CLAIMS OF PRIORITY

This patent application claims priority from:

(1) CN utility model patent application number is 202420253354.6 with a filing date of Feb. 2, 2024 and DAS code of 7E5A.

### TECHNICAL FIELD

The present disclosure relates to the technical field of assistive equipment, in particular to a bedside step

### DESCRIPTION OF THE PRIOR ART

In daily life, it is inconvenient for the elderly or patients with weak legs or feet to get on and off the bed, therefore, in order to facilitate getting on and off the bed, an assistive step will be placed at the bedside. The bedside step provided by the prior art is relatively simple in structure, and the function is also very simple. With such bedside step, there is a lack of supporting parts for the user to get on and off the bed, and it is difficult for the user to discern the position of the step in the dark. This leads to the inconvenience of the use of the existing bedside step, which can not adapt to various use environments, and can not meet the needs of users. Therefore, a new type of bedside step is needed.

### SUMMARY OF THE DISCLOSURE

In order to solve the problem that the function of the existing bedside step is single and the use is inconvenient, and to meet the user's demand, the present disclosure provides a bedside step.

In order to achieve the above purposes, the disclosure provides a bedside step comprising an underframe, a base plate and a sideframe, wherein the sideframe is disposed at one end of the underframe, the base plate is disposed on the underframe, a plurality of sensor lamps are disposed in the underframe, the base plate is provided with a plurality of holes whose positions correspond to positions of the plurality of sensor lamps, a sensor which is electrically connected with the plurality of sensor lamps is disposed on the sideframe, and a plurality of support rods are further disposed at a bottom of the underframe. Preferably, two symmetrical sides of the underframe are respectively provided with a lamp groove, and the plurality of sensor lamps are disposed in these lamp troughs.

Preferably, the sensor is an infrared sensor.

Preferably, the bedside step further comprises a plurality of adjusting rods and a plurality of first fixing members, each of the plurality of support rods is provided with at least one first adjusting hole, each of the plurality of adjusting rods is provided with a first fixing hole and is inserted in one of the plurality of support rods, and the plurality of first fixing members are each penetrated through one of the at least one first adjusting hole and the first fixing hole to fixedly connect the plurality of adjusting rods and the plurality of supporting rods.

Preferably, the sideframe comprises a first vertical rod, a second vertical rod, a handrail and a plurality of second fixing member, the first vertical rod and the second vertical rod are respectively provided with at least one second adjusting hole, two ends of the handrail are respectively provided with a second fixing hole, the two ends of the handrail are inserted into the first vertical rod and the second vertical rod respectively, and the plurality of second fixing member are each penetrated through one of the at least one second adjusting hole and the second fixing hole to fixedly connect the handrail with the first vertical rod and the second vertical rod respectively.

Preferably, the sideframe further comprises a first cross rod and a second cross rod, the first cross rod and the second cross rod are disposed in parallel and are connected with the first vertical rod and the second vertical rod respectively.

Preferably, the sensor is disposed on the first cross rod or the second cross rod.

Preferably, at least one mounting buckle is disposed at the bottom of the underframe.

Preferably, material of the base plate is one of EVA, PVA or rubber.

Through the implementation of the above technical solution, the following technical effects can be obtained: according to the bedside step provided by the disclosure, by means of the providing of sensor and sensor lamps, when the user approaches the bedside step, the sensor senses the approach of human body through the infrared rays, the sensor lamps light up in the underframe immediately; the light rays of the sensor lamps are transmitted through the holes in the base plate, so that the user can judge the position of the step even in the dark, and can get on and off the bed with lighting assist, which can adapt to more environments, and further facilitates the user, thereby solving the technical problem that the function of the existing bedside step is single, and it is inconvenient to use.

### BRIEF DESCRIPTION OF DRAWINGS

FIG. 1 is a structure diagram of a bedside step provided by the embodiments of the present disclosure;

FIG. 2 is a top view of a bedside step provided without a base plate by the embodiments of the present disclosure;

FIG. 3 is a structure diagram of a bedside step provided by the embodiments of the present disclosure;

FIG. 4 is a close-up view of local structure of a bedside step provided by the embodiments of the present disclosure;

FIG. 5 is another close-up view of local structure of a bedside step provided by the embodiments of the present disclosure;

FIG. 6 is a structure diagram of a bedside step in using state provided by the embodiments of the present disclosure.

### REFERENCE NUMERALS

1 underframe; 2 base plate; 3 sideframe; 4 sensor; 5 support rod; 6 adjusting rod; 7 bed; 11 lamp trough; 12 sensor lamp; 13 mounting buckle; 21 hole; 31 first vertical rod; 32 second vertical rod; 33 handrail; 34 first cross rod; 35 second cross rod; 36 second fixing member; 37 second adjusting hole; 51 first adjusting hole; 61 first fixing member.

### DESCRIPTION OF EMBODIMENTS

In order to better understand the technical solution of the present disclosure, the embodiments provided by the present disclosure will be described in detail below in conjunction with the accompanying drawings.

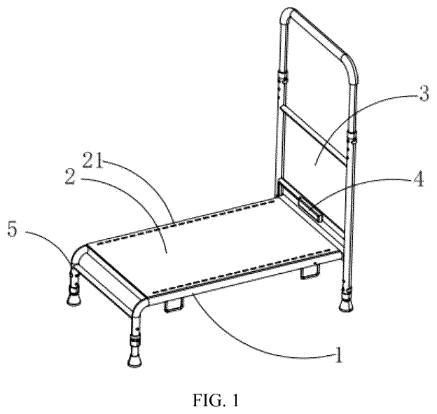

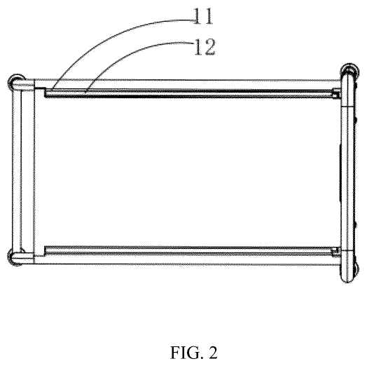

Referring to FIG. 1-2, the disclosure discloses a bedside step comprising an underframe 1, a base plate 2 and a sideframe 3. The sideframe 3 is disposed at one end of the underframe 1. A plurality of sensor lamps 12 are disposed in the underframe 1, and the base plate 2 is disposed on the underframe 1. The base plate 2 is provided with a plurality of holes 21 whose positions correspond to positions of the plurality of sensor lamps 12. A sensor 4 which is electrically connected with the plurality of sensor lamps 12 is disposed on the sideframe 3, and a plurality of support rods 5 are further disposed at a bottom of the underframe 1.

Therefore, according to the bedside step provided by the disclosure, by means of the providing of the sensor lamps 12 and the sensor 4, when the user approaches the bedside step, the sensor 4 senses the approach of human body, the sensor lamps 12 light up in the underframe immediately. The light rays of the sensor lamps 12 are transmitted through the holes 21 in the base plate, so that the user can judge the position of the bedside step even in the dark. The sensor lamps 12 on the bedside step can assist the user to get on and off the bed with lighting, which can further satisfy the user's demand and provide convenience for the user.

On the basis of the above embodiments, further, in other embodiments, the two symmetrical sides in the underframe 1 are respectively provided with a lamp trough 11, and the sensor lamps 12 are disposed in these lamp troughs 11. A plurality of holes 21 are disposed on two symmetrical sides of the base plate 2. The sensor lamps 12 can be in the form of light strip, and the light rays from the sensor lamps 12 are transmitted through the holes 21.

On the basis of the above embodiments, further, in other embodiments, the sensor 4 is an infrared sensor. When a user approaches the bedside step, a certain part of human body is in the infrared sensing region of the sensor 4, and due to infrared rays reflected, the sensor 4 receives a signal and transmits the signal to the sensor lamps 12, so that the sensor lamps 12 can light up. The infrared sensor responds quickly and has high sensitivity, which can effectively improve the efficiency and effect of light-up of the bedside step.

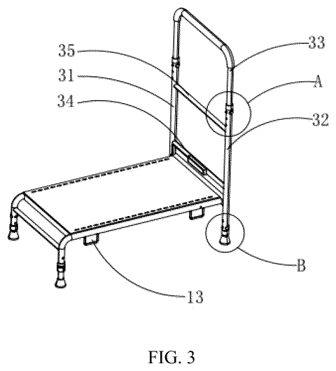

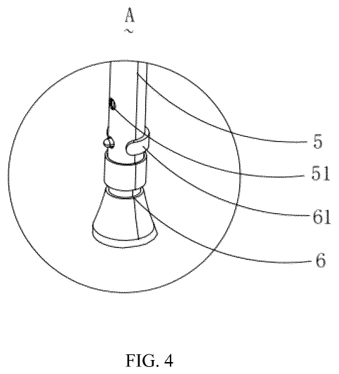

On the basis of the above embodiments, further, in other embodiments, referring to FIGS. 3-4, the bedside step further comprises a plurality of adjusting rods 6 and a plurality of first fixing members 61. Each of the plurality of support rods 5 is provided with at least one first adjusting hole 51. Each of the plurality of adjusting rods 6 is provided with a first fixing hole (not marked in the FIGS.) and is inserted in one of the plurality of support rods 5. The first fixing hole corresponds to the position of one first adjusting hole 51 when mounting. The plurality of first fixing members 61 are each penetrated through one of the at least one first adjusting hole 51 and the first fixing hole to fixedly connect the plurality of adjusting rods 6 and the plurality of supporting rods 5. Because a plurality of first adjusting holes 51 are provided, each adjusting rod 6 can be adjusted by adjusting the position of the first fixing hole and the first adjusting hole 51, so that the height adjustment of the underframe 1 can be realized, and a suitable height can be selected.

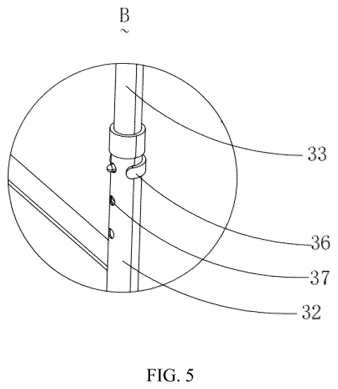

On the basis of the above embodiments, further, in other embodiments, referring to FIG. 5, the sideframe 3 comprises a first vertical rod 31, a second vertical rod 32, a handrail 33 and a plurality of second fixing members 36. The first vertical rod 31 and the second vertical rod 32 are respectively provided with at least one second adjusting hole 37. The two ends of the handrail 33 are respectively provided with a second fixing hole (not marked in the FIG.). The two ends of the handrail 33 are inserted in the first vertical rod 31 and the second vertical rod 32 respectively. The second fixing hole corresponds to the position of the plurality of second adjusting holes 37 when mounting. The plurality of second fixing member 36 are each penetrated through one of the at least one second adjusting hole 37 and the second fixing hole to fixedly connect the handrail 33 with the first vertical rod 31 and the second vertical rod 32 respectively. Similarly, because a plurality of second adjusting holes 37 are provided, the height of the handrail 33 can be adjusted by adjusting the position of the second fixing hole and the second adjusting hole 37, so that bring convenience to the user.

On the basis of the above embodiments, further, in the other embodiments, the sideframe 3 further comprises a first cross rod 34 and a second cross rod 35. The first cross rod 34 and the second cross rod 35 are disposed in parallel and are connected with the first vertical rod 31 and the second vertical rod 32 respectively. The providing of the first cross rod 34 and the second cross rod 35 make the sideframe 34 more stable, and it is safer when user using the sideframe 3 as a handrail.

On the basis of the above embodiments, further, in other embodiments, the sensor 4 is disposed on the first cross rod 34 or the second cross rod 35, so that the sensor 4 can receive the signal of the human body in time and respond in time, which is very convenient.

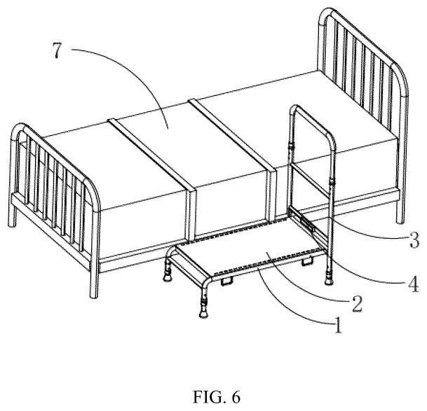

On the basis of the above embodiments, further, in other embodiments, referring to FIG. 6, at least one mounting buckle 13 is disposed at the bottom of the underframe 1. Specifically, in the present embodiment, two mounting buckles 13 are respectively disposed on the two symmetrical sides of the underframe 1, and the bedside step can be fixed on the bed 7 through the external mounting belt through the mounting buckle 13. The providing of the mounting buckle 13 make the mounting of the bedside step firmer and more stable.

On the basis of the above embodiments, further, in the other embodiments, the material of the base plate 2 is one of EVA, PVA or rubber. Preferably, in the present embodiment, the material of the base plate 2 is EVA. On one hand, the EVA material has certain wear resistance and weather resistance, so the base plate is not susceptible to external damage, on the other hand, the base plate of EVA material is softer than common materials, and has certain slip resistance, which further improves the safety and comfort of the product, and improves the user experience.

According to the bedside step provided by the disclosure, by means of the providing of sensor and sensor lamps, when the user approaches the bedside step, the sensor senses the approach of human body through the infrared rays, the sensor lamps light up in the underframe immediately; the light rays of the sensor lamps are transmitted through the holes in the base plate, so that the user can judge the position of the step even in the dark, and can get on and off the bed with lighting assist, which can adapt to more environments, and further facilitates the user, thereby solving the technical problem that the function of the existing bedside step is single, and it is inconvenient to use.

The above is a detailed description to a bedside step provided by the disclosure. For those skilled in the art, according to the idea of the present disclosure, there will be changes in the specific embodiment and the scope of application, and in summary, the contents of this specification should not be understood as a restriction on the present application.

What is claimed is:

1. A bedside step, comprising an underframe, a base plate and a sideframe, wherein the sideframe is disposed at one end of the underframe, the base plate is disposed on the underframe, a plurality of sensor lamps are disposed in the underframe, the base plate is provided with a plurality of holes whose positions correspond to positions of the plurality of sensor lamps, a sensor which is electrically connected with the plurality of sensor lamps is disposed on the sideframe, and a plurality of support rods are further disposed at a bottom of the underframe.

2. The bedside step of claim 1, wherein two symmetrical sides of the underframe are respectively provided with a lamp trough, and the plurality of sensor lamps are disposed in these lamp troughs.

3. The bedside step of claim 2, wherein the sensor is an infrared sensor.

4. The bedside step of claim 3, wherein the bedside step further comprises a plurality of adjusting rods and a plurality of first fixing members, each of the plurality of support rods is provided with at least one first adjusting hole, each of the plurality of adjusting rods is provided with a first fixing hole and is inserted in one of the plurality of support rods, and the plurality of first fixing members are each penetrated through one of the at least one first adjusting hole and the first fixing hole to fixedly connect the plurality of adjusting rods and the plurality of supporting rods.

5. The bedside step of claim 4, wherein the sideframe comprises a first vertical rod, a second vertical rod, a handrail and a plurality of second fixing member, the first vertical rod and the second vertical rod are respectively provided with at least one second adjusting hole, two ends of the handrail are respectively provided with a second fixing hole, the two ends of the handrail are inserted into the first vertical rod and the second vertical rod respectively, and the plurality of second fixing member are each penetrated through one of the at least one second adjusting hole and the second fixing hole to fixedly connect the handrail with the first vertical rod and the second vertical rod respectively.

6. The bedside step of claim 5, wherein the sideframe further comprises a first cross rod and a second cross rod, the first cross rod and the second cross rod are disposed in parallel and are connected with the first vertical rod and the second vertical rod respectively.

7. The bedside step of claim 6, wherein the sensor is disposed on the first cross rod or the second cross rod.

8. The bedside step of claim 1, wherein at least one mounting buckle is disposed at the bottom of the underframe.

9. The bedside step of claim 1, wherein material of the base plate is one of EVA, PVA or rubber.
